(19) United States
(12) Patent Application Publication
(10) Pub. No.: US 2023/0145783 A1
(43) Pub. Date: May 11, 2023

(54) PARALLEL PROCESSING FOR COMBINATORIAL OPTIMIZATION

(71) Applicant: NVIDIA Corporation, Santa Clara, CA (US)

(72) Inventors: Mehmet Akif Çördük, Munich (DE); Frank Joseph Eaton, Austin, TX (US); Alexandre Jacques Antoine Fender, Austin, TX (US); Hugo Linsenmaier, Zurich (CH); Shankara Rao Thejaswi Nanditale, Haar (DE)

(21) Appl. No.: 17/521,440

(22) Filed: Nov. 8, 2021

(51) Int. Cl. G06F 9/48; G06F 9/38; G06F 9/455; G06F 9/50

(52) U.S. Cl. CPC G06F 9/4881; G06F 9/3877; G06F 9/5072; G06F 9/45558; G06F 2009/4557

(57) ABSTRACT

In various examples, solutions to combinatorial optimization problems are determined using a plurality of solvers executing in parallel. In an embodiment, the plurality of solvers executed in parallel perform one or more search algorithms. Furthermore, in such embodiments, the operations of the one or more search algorithms are also executed in parallel.

### BACKGROUND

Finding a solution to a combinatorial optimization problem has a factorial complexity that creates a search space that is difficult to search, particularly as the number of elements and constraints involved increases. For example, a set of fifteen objects for a problem with a factorial complexity has a search space with over a trillion possible solutions. In addition, algorithms and heuristics used by traditional systems may not be parallelized or, at best, only mildly parallelized. Due to the limited parallelization offered by conventional approaches, the size of the search space that is explored is often a relatively small fraction of the available search space in order to allow solutions to be determined in a computationally efficient manner. That is, if the search space is large enough, then identifying a solution with traditional approaches may take too long or consume too many resources for practical applications. As such, the number of potential solutions and/or optimal solutions that can be determined may be limited using conventional approaches and processing techniques. Therefore, accuracy and optimal solutions are often sacrificed to reduce computational intensity and time.

### SUMMARY

Embodiments of the present disclosure relate to parallel processing for combinatorial optimization problems. Systems and methods are disclosed that execute a plurality of tasks (e.g., globalizing heuristics, efficient communications, hill climbers, compute engines, local optimizer or other solvers) in parallel, where the operations of a particular task of the plurality of tasks can also be executed in parallel, to determine a solution (e.g., high-quality solution) to a combinatorial optimization problem. In one example, the plurality of tasks, as a result of being executed by one or more processors, implement one or more algorithms, heuristics, metaheuristics, deep learning, and/or artificial intelligence techniques to determine a solution to the combinatorial optimization problem.

In contrast to conventional systems, such as those described above, the systems and methods described in the present disclosure leverage parallel processing capabilities of one or more parallel processing units (PPUs), such as a graphical processing unit (GPU), to quickly and efficiently determine a solution to various combinatorial optimization problems and/or other nondeterministic polynomial-time hard (NP-hard) problems. One example of a combinatorial optimization problem includes routing problems (e.g., traveling salesman, delivery trucks, robots, etc.) where the output (e.g., a determined solution) must comply with a plurality of constraints (e.g., delivery time, number of orders, etc.). Furthermore, in contrast to conventional systems, parallelization (e.g., execution by one or more PPUs) allows for increased speed and accuracy as well as dynamic recalculation as a result of unpredicted disruptions. For example, recalculation of one or more routes can be executed dynamically in response to weather conditions that cause one or more routes to be closed.

### BRIEF DESCRIPTION OF THE DRAWINGS

The present systems and methods for parallel processing for combinatorial optimization problems are described in detail below with reference to the attached drawing figures, wherein:

FIG. 1 illustrates a method for determining a solution to a combinatorial optimization problem utilizing a plurality of solvers executed by PPUs in parallel, in accordance with at least one embodiment;

FIG. 2 illustrates an example of an environment in which parallel processing units (PPUs) are used to generate a solution to routing problem, in accordance with at least one embodiment;

FIG. 3 illustrates an example in which a solver executed by a PPU modifies solutions to a combinatorial optimization problem, in accordance with at least one embodiment;

FIG. 4 illustrates a method for determining a solution to a combinatorial optimization problem utilizing a plurality of solvers executed by PPUs in parallel, in accordance with at least one embodiment;

FIG. 5 illustrates a method for escaping a local minimum utilizing a plurality of solvers executed by PPUs in parallel, in accordance with at least one embodiment;

FIG. 6 illustrates a parallel processing unit, in accordance with an embodiment.

FIG. 7A illustrates a general processing cluster within the parallel processing unit of FIG. 6, in accordance with an embodiment;

FIG. 7B illustrates a memory partition unit of the parallel processing unit of FIG. 6, in accordance with an embodiment;

FIG. 8A illustrates the streaming multi-processor of FIG. 7A, in accordance with an embodiment;

FIG. 8B is a conceptual diagram of a processing system implemented using the PPU of FIG. 6, in accordance with an embodiment;

FIG. 8C illustrates an exemplary system in which the various architecture and/or functionality of the various previous embodiments may be implemented;

FIG. 9 is a conceptual diagram of a graphics processing pipeline implemented by the PPU of FIG. 6, in accordance with an embodiment; and

FIG. 10 is a block diagram of an example data center suitable for use in implementing some embodiments of the present disclosure.

### DETAILED DESCRIPTION

Systems and methods are disclosed related to parallel processing for combinatorial optimization problems. In particular, solutions to various types of problems (e.g., satisfiability problem) such as vehicle routing problems, bin packing problems, job shop scheduling problems, and other NP-hard problems can be determined using parallel processing techniques described in greater detail below. In addition, in various embodiments, multi-level parallel processing techniques are used to quickly and efficiently compute and/or re-compute solutions. For example, as described in greater detail below a plurality of compute engines (e.g., hill climbers, local optimizer, or other solver) are executed in parallel by one or more parallel processing units (PPUs) and the operations of the compute engines are also executed in parallel.

In various embodiments, a plurality of initial solutions are generated and used to seed the plurality of compute engines. In one example, an insertion algorithm is used to generate a plurality of seeds which are assigned to a plurality of hill climbers. In such examples, by variating the initial solutions, the compute engines are initialized at various different locations within a search space associated with a combinatorial optimization problem for which the compute engines determine a solution. In one embodiment, the initial solutions are variated by at least modifying a set of hyperparameters. In this manner, a large number of compute engines (e.g., thousands) starting at different location within a multi-dimensional search space can increase the probability of computing an optimal solution efficiently, in accordance with at least one embodiment.

Furthermore, in various embodiments, one or more objective functions are used to determine optimal solutions. For example, in determining an optimal solution to a vehicle routing problem, a first objective function to minimize the number of vehicles and a second objective function to reduce the total distance travelled are used to determine optimal and/or improved solutions. In some embodiments, the number of compute engines is modified (e.g., increased or decreased) based at least in part on various factors such as computing budget (e.g., time), efficiency, solution requirements, or other constraints.

As described in greater detail below, in an embodiment, the compute engines include source code or other executable code that, as a result of being executed by one or more PPUs, cause the one or more PPUs to perform various operations of a search algorithm including heuristics and/or metaheuristics. In one example, the compute engines compute improvements to the initial solutions and/or current solution. In various embodiments, the compute engines communicate by at least sharing information associated with execution (e.g., solutions within the search space). For example, the compute engines write information to and share a list (e.g., a penalty list) of modifications to a solution that the compute engines are prevented from making (e.g., forbidden moves) representing local maxima. Returning to the example above, in determining the optimal solution to the vehicle routing problem the compute engines cause the PPUs to execute operations to improve the routes.

In various embodiments, the operations of the compute engines (e.g., execution of the search algorithm) are executed in parallel. For example, a particular search algorithm includes both inter-route improvements and intra route improvements, these operations of the search algorithm are executed in parallel by one or more components of a PPU. In an embodiment, execution of the search algorithm by the compute engines is divided into two phases, candidate generation and move execution. In such embodiments, during candidate generation potential solutions are generated. In various examples, feasible solutions as well as infeasible solutions (e.g., a solution that violates one or more constraints) are generated during the candidate generation phase. In an embodiment, one or more light constraints are used during candidate generation. For example, light constraints such as vehicle lower bound, vehicle capacities, or other scalar constraints are used to prune solutions generated during candidate generation.

In the move execution phase, in at least one embodiments, one or more heavy constraints are utilized. In one example, during the move execution phase candidates (e.g., solutions generated during the candidate generation phase) are sorted and processed based at least in part on the one or more heavy constraints. The one or more heavy constraints include, for example, wait time, delivery time, cost controls, resource limitations, load processing, or other constraints. In various embodiments, the constraints (e.g., light and heavy constraints) are provided by a user. In yet other embodiments, the solvers are assigned solutions generated based at least in part by the user (e.g., solutions generated by a machine learning model). In addition, in some examples, the initial solutions are generated without satisfying all of the constraints. Furthermore, the search algorithm executed by the compute engines, are executed until a processing budget is exceeded and an optimal solution is selected, in accordance with at least one embodiment. In an example, the optimal solution is determined based at least in part on a computed savings value with an objective (e.g., reduce distance, reduce routes, reduce vehicles, etc.). In various embodiments, the search algorithm executed by the compute engines can be used to maximize or minimize solutions to the combinatorial optimization problem.

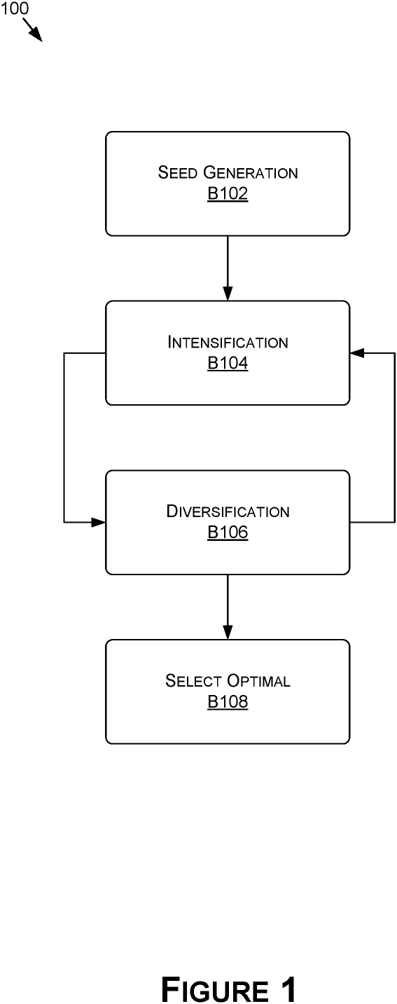

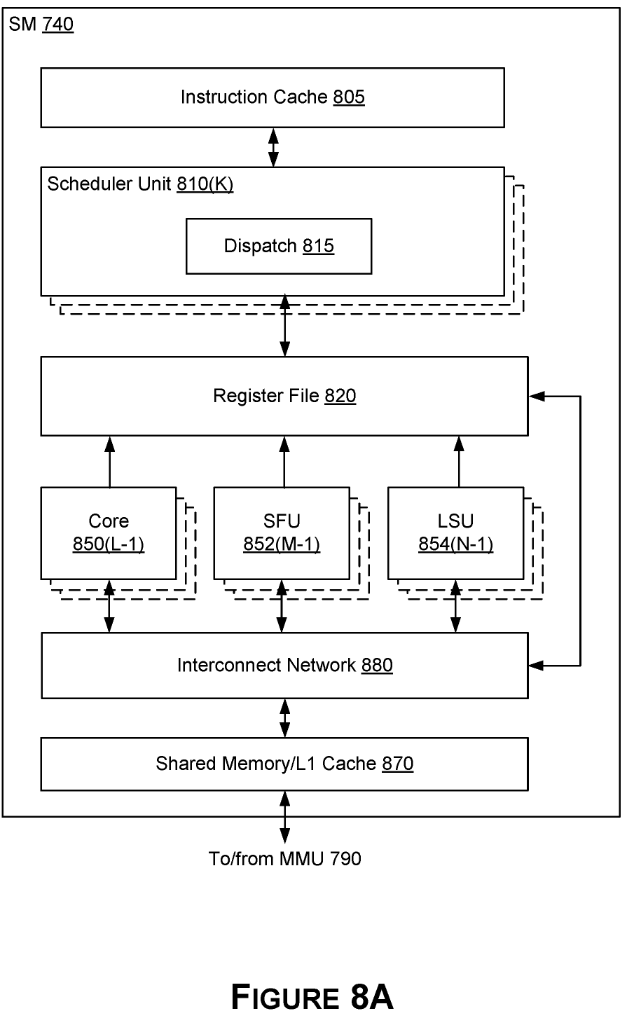

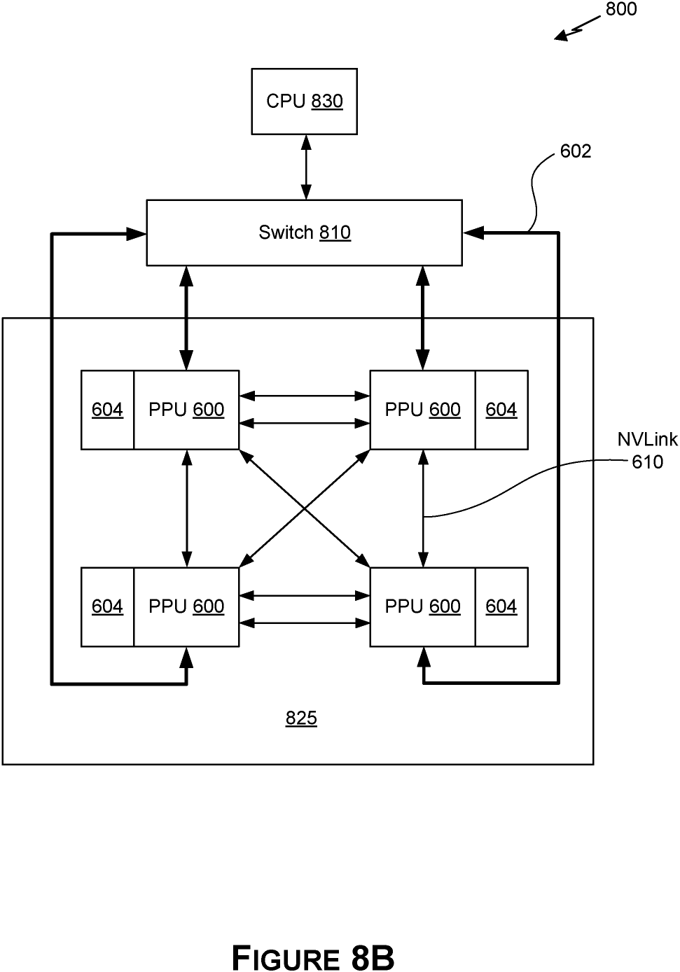

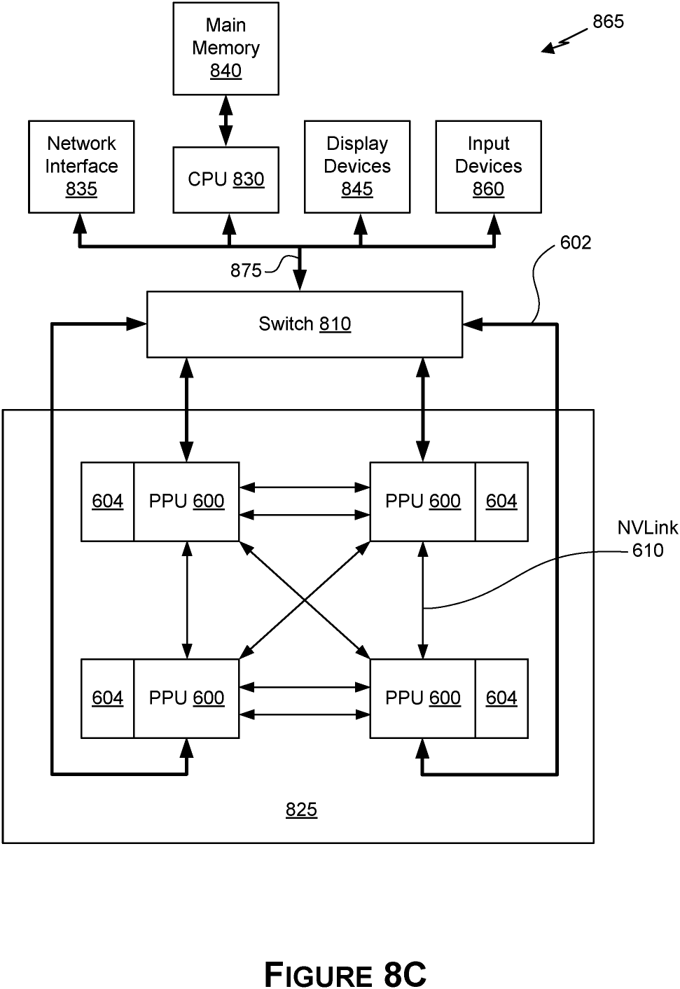

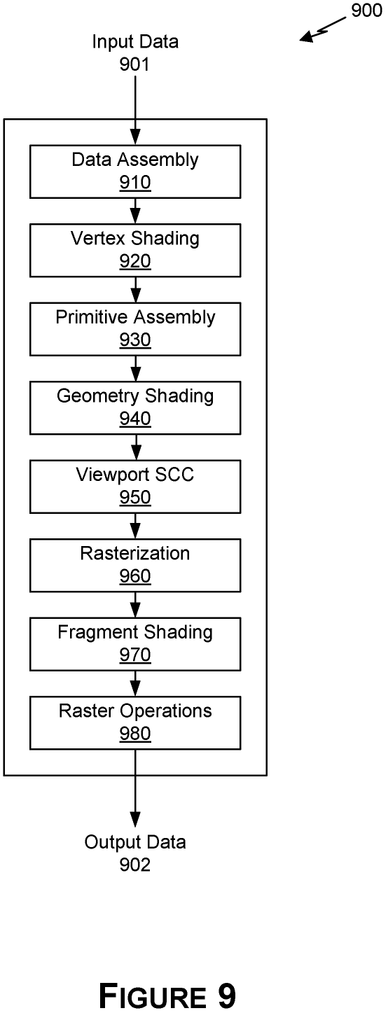

Now referring to FIGS. 1, 4, and 5, each block of methods 100, 400, and 500, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 100 is described, by way of example, with respect to the systems of FIGS. 8 and 9. However, this method may additionally or alternatively be executed by any one system, or any combination of systems, including, but not limited to, those described herein.

FIG. 1 is a flow diagram showing a method 100 for determining a solution to a combinatorial optimization problem utilizing a plurality of solvers executed by one or more parallel processing units (PPUs) in parallel, in accordance with some embodiments of the present disclosure. In various embodiment, the system executing the method 100, at block B102, generates a plurality of seeds. In one example, the plurality of seeds includes solutions to the combinatorial optimization problem for which the plurality of solvers generate solutions. In an embodiment, an insertion algorithm or other method is used to generate the plurality of seeds. In yet other embodiments, the plurality of seeds are randomized. In addition, during seed generation, the seeds (e.g., initial solutions) are assigned to solvers (e.g., hill climbers, local optimizers, and/or other solvers) and the solvers are assigned identification information (e.g., solverID and/or block ID). In one example, the insertion algorithm is defined by the following equations to determine the best insertion index for un-routed nodes:

$${c}_{11} \left(i , u , j\right) = {d}_{i u} + {d}_{u j} - μ {d}_{i j ,} μ \geq 0 ;$$

$${c}_{12} \left(i , u , j\right) = {b}_{{j}_{u}} - {b}_{j}$$

$${c}_{1} \left(i \left(u\right) , u , j \left(u\right)\right) = min \left[{c}_{1} \left({i}_{p - 1} , u , {i}_{p}\right)\right] , p = 1 , … , m .$$

In addition, in such an example, the insertion algorithm determines the best node to be inserted based at least in part on the following equations:

$${c}_{1} \left(i , u , j\right) = {α}_{1} {c}_{11} \left(i , u , j\right) + {α}_{2} {c}_{12} \left(i , u , j\right) , {α}_{1} + {α}_{2} = 1$$

$${α}_{1} \geq 0 , {α}_{2} \geq 0 ;$$

$${c}_{2} \left(i , u , j\right) = \text{λ} {d}_{{0}_{u}} - {c}_{1} \left(i , u , j\right) , \text{λ} \geq \text{0;}$$

where different seeds (e.g., initial solutions) are generated by at least variating the hyperparameters µ, α₁, α₂, and λ. At block B104, in various embodiment, the system executing the method 100, executes an intensification phase where the plurality of solvers execute one or more search algorithms to generate solutions. For example, the one or more search algorithms include branch and bound algorithms, dynamic programming algorithms, insertion algorithms, Kernigan-Lin swap algorithms, k-opt swaps algorithms, relocations algorithms, simulated annealing algorithms, tabu search algorithms, guided local search algorithms, deep learning algorithms (e.g., reinforcement learning, transformer network, etc.), and other algorithm suitable for searching a multi-dimensions search space. In addition, in various embodiments, the solvers executing the one or more search algorithms execute operations of the search algorithm in parallel. In one example, the combinatorial optimization problem includes a vehicle routing problem and the plurality of solvers include hill climbers, the hill climbers execute inter-route improvements, intra-route improvements, tabu search, and/or guided local search in parallel. In various embodiments, information exchange between the solvers can be efficiently performed as a result of the number (e.g., thousands) of solvers executing in parallel. In addition, in an embodiment, one or more improvements (e.g., good features of a particular solution) can be rewarded by at least causing a savings value or objective function to be increased (e.g., in addition to or as an alternative to penalizing one or more features).

At block B106, in various embodiment, the system executing the method 100, executes a diversification phase where the plurality of solvers modify solutions to increase an explored area of the search space. For example, feasible as well as unfeasible solutions are searched. In another example, unwanted features in the solutions are penalized. In various embodiments including vehicle routing problems, the solvers utilize separate matrices for distance penalties and a common matrix (e.g., a matrix maintained in a storage location accessible to the solvers) for wait penalties. Various other techniques can be used to expand the number of different solutions explored by the solvers such as randomization, penalizing certain features, violating one or more constraints, or other techniques to variate solutions, in accordance with at least one embodiment.

At block B106, in various embodiment, the system executing the method 100, selects an optimal solution generated by the solvers. In one example, the optimal solution is selected based at least in part on an objective function. In various embodiments, the objective function consists of one or more outputs. In one example, the objective function and one or more outputs include the number of vehicles and the total distance travelled. In another example, the objective function includes an amount of constraints violated.

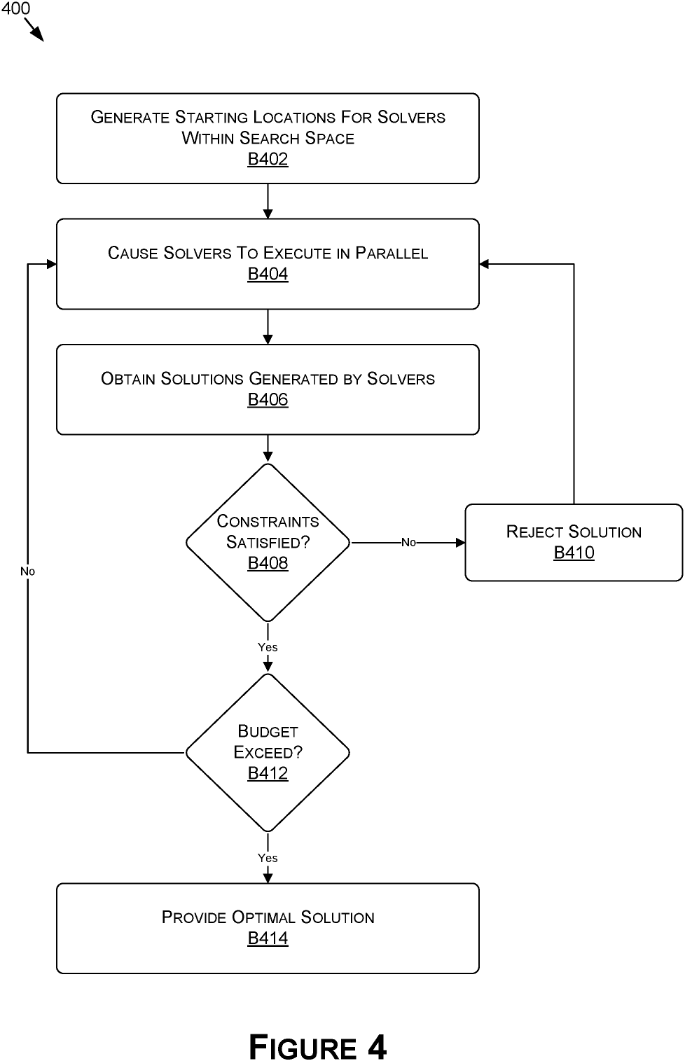

In various embodiments, the set of candidates generated by the solvers are maintained in a sorted list. In various embodiments, the solvers maintain the solution with the optimal saving value and/or objective function value (e.g., maximum or minimum) that is updated at the end of an iteration (e.g., completion of the candidate generation phase and improvement phase). As described in greater detail below in connection with FIG. 4, the solution to the combinatorial optimization problem is determined (e.g., once the execution budget is exceeded) by at least comparing the solutions generated by the plurality of solvers in parallel. Furthermore, as illustrated in FIG. 1, the method 100, in various embodiments, continues the intensification phase (e.g., block B104) and the diversification phase (e.g., B106). For example, the system executing the method 100 can alternate between intensification and diversification until an execution budget is met or exceeded. In an embodiment, the execution budget includes an interval of time during which the method 100 is executed. In yet other embodiments, the execution budget includes a cost associated with processing of the method 100.

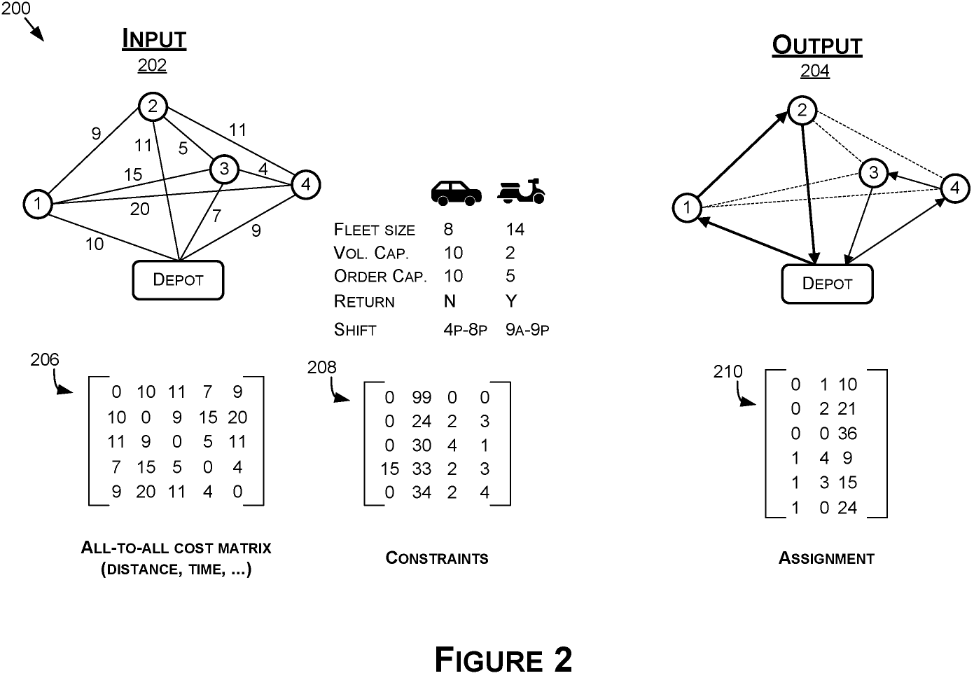

FIG. 2 illustrates an example 200 in which parallel processing units (PPUs) are used to generate a solution to a vehicle routing problem in accordance with at least one embodiment. In various embodiments, the input 202 includes a set of nodes (e.g., destinations) and a depot (e.g., a location from which the vehicles depart and/or return). In addition, in an embodiment, the input 202 includes a cost matrix 206 and a set of constraints 208. In one example, the cost matrix 206 includes an all-to-all cost matrix representing distances (e.g., time, miles, effort, energy, etc.) between nodes and/or the depot. In various embodiments, the cost matrix 206 and/or distance information can be obtained from various locations including a map application, direct calculation, database, or other storage locations.

In various embodiments, the set of constraints 208 include various constraints on the vehicle routing problem to be solved, that may include, for example and without limitation, delivery times (e.g., earliest time, latest time, etc.), delivery duration, vehicle capacity, vehicle volume, vehicle weight, vehicle cost of operation, fleet size, shift duration, return location, number of deliveries, wait time, or other constraints. In one example, the vehicle routing problem includes an arbitrary number of constraints. Furthermore, as illustrated in FIG. 2, the constraints can include a matrix, and be used by one or more solvers to generate solutions to the vehicle routing problem.

In various embodiments, the output 204 includes an assignment 210 defining a set of routes that represent a solution to the vehicle routing problem. For example, the output 204 includes the assignment of vehicles to nodes (e.g., stops) and time information. In various embodiments, the output 204 is generated by a plurality of compute engines of PPUs using various techniques described in the present disclosure. In one example, the output 204 is generated using the methods 100 and 400. In an embodiment, a hill climber is assigned an initial solution generated based at least in part on the input 202 including the cost matrix 206 and the set of constraints 208. Furthermore, in such embodiments, a plurality of hill climbers are instantiated, assigned different initial solutions, and executed in parallel. During execution, the plurality of hill climbers determine improvements to the initial solution by at least modifying elements of the assignment 210, in accordance with at least one embodiment. In one example, a vehicle assigned to a particular node is reassigned to another node and a savings value (e.g., distance reduction, cost reduction, efficiency improvement) is calculated to determine if the reassignment results in an improvement (e.g., lower or higher depending on whether the value is to be minimized or maximized). In various embodiments, the initial solution can be improved using a variety of algorithms and heuristics as described in the present disclosure. In one example, vehicles can be reassigned to new nodes and improvements can be determined until an execution budget is exhausted.

In various embodiments, the compute engine refers to a hardware schedulable group of threads that may be used for parallel processing. In one example, a thread refers to a PPU (e.g., graphical processing unit) thread or other processing thread (e.g., central processing unit). In various examples, the threads are be implemented, at least in part, using a Single Instruction, Multiple Thread (SIMT) execution model. A thread may also be referred to as a work item, a basic element of data to be processed, an individual lane, or a sequence of Single Instruction, Multiple Data (SIMD) lane operations, in accordance with at least one embodiment.

Examples of schedulable units include warps in relation to NVIDIA (RTM) terminology (e.g., Compute Unified Device Architecture (CUDA) based technology) or wavefronts in relation to AMD (RTM) terminology (e.g., OpenCL-based technology). For example, CUDA-based technology includes compute engines that, by way of example and not limitation, comprise 32 threads. In various other examples, the compute engines, by way of example and not limitation, comprise 64 threads. In one or more embodiments, the compute engines refer to a thread of SIMD instructions. In one or more embodiments, the compute engines comprise a collection of operations that execute in lockstep, run the same instructions, and follow the same control-flow path. In some embodiments, individual or groups of lanes or threads of compute engines can be masked off from execution. In various embodiments, the solvers and/or hill climbers described in the present disclosure are assigned to compute engines for parallel processing.

In various embodiments, various features of the solutions, such as constraint violations, are favored and/or other features are penalized. In one example, initial solutions generated based at least in part on the input favor nodes further away (e.g., nodes with a high distance value from the depot or other starting location). In another example, the penalized features are chosen from one or more structural properties of the solution (e.g., long distances, long wait times, etc.). In such examples, as improvements to the solution are generated by the solvers, local optimizers, and/or hill climbers, nodes that are further away are penalized. In various embodiments, a tightness of the delivery window (e.g., the earliest time and the latest time at which a node can be visited) is defined by the following equation:

$$\frac{Σ \left({l}_{i} - {e}_{i}\right)}{N \times \left({l}_{0} - {e}_{0}\right)}$$

where l is the latest time, e is the earliest time, and N is the number of nodes. In one example, the tightness value computed based at least in part on the equation above is used to evaluate solutions (e.g., the output 204) generated by a compute engine. In various embodiments, the tightness of the delivery winder (e.g., based at least in part on the value computed using the equation above), in addition to other parameters, (e.g., distance, wait time, etc.), is used to determine one or more features to penalize.

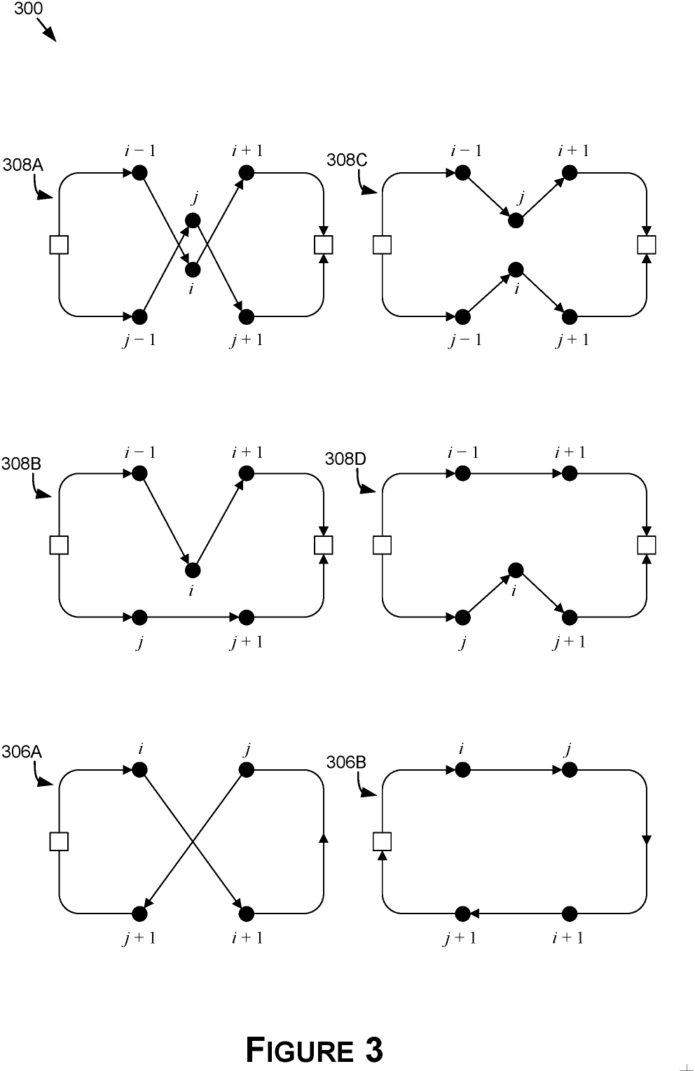

FIG. 3 illustrates an example 300 in which a solver executed by a PPU modifies solutions to a combinatorial optimization problem, in accordance with at least one embodiment. In various embodiments, once a set of solvers (e.g., hill climbers) are initialized with a set of solutions to the combinatorial optimization problem, the set of solvers determine improvements to the set of solutions in order to determine an optimal or improved solution to the combinatorial optimization problem. In the example 300 illustrated in FIG. 3, the improvements include intra-route 306A and 306B improvements and inter-route improvements 308A-308D.

In an embodiment, the intra-route 306A and 306B improvements include improvement to a particular route (e.g., shorter distance, less time, improved terminus, lower cost, etc.). In an example, various intra-route improvements are computed by one or more threads of the compute engine in parallel. In the example illustrated in FIG. 3, the distance between i and j is less than i to i + l therefore the value of the savings available via the intra-route improvement 306B is greater that the savings available through intra-route improvement 306A. In various embodiments, modifications to the solutions are generated (e.g., candidate generation) and then the candidates are evaluated based at least in part on a computed savings value and/or a set of constraints to the solution, improvements to the solution are then made by at least assigning the solver to the improved solution (e.g., the solution comprising the intra-route improvement 306B). Similarly, in various embodiments, the inter-route improvements 308A-308D are computed in parallel. For example, as illustrated in FIG. 3, the solver generates a set of candidates (e.g., potential solutions) where the distance between i - l the solver swaps i and j between the first and second route to generate the inter-route improvement 308C. Furthermore, in various embodiments, both the inter-route improvements and the intra-route improvements are computed in parallel.

FIG. 4 is a flow diagram showing a method 400 for determining a solution to a combinatorial optimization problem utilizing a plurality of solvers executed by one or more parallel processing units (PPUs) in parallel, in accordance with some embodiments of the present disclosure. In various embodiments, the system executing the method 400, at block B402, generates a set of starting locations for solvers within a search space of the combinatorial optimization problem. In one example, an insertion algorithm is used to generate a plurality of solutions to the combinatorial optimization problem based at least in part on a set of constraints. In various embodiments, the number of solutions can be determined by a user. Furthermore, in various embodiments, the set of solutions (e.g., starting locations within the search space) are assigned to a set of solvers. For example, the set of solvers may comprise hill climbers implemented using executable code that, as a result of being executed by the PPU, perform the operations of the method 400.

At block B404, the system executing the method 400 causes the solvers to execute in parallel, in accordance with an embodiment. In one example, the solvers are executed by a plurality of PPUs. As described above, the solvers, in various embodiments, execute operations of one or more search algorithms. Furthermore, the solvers, in an embodiment, may be assigned state information indicating a state of the search algorithm (e.g., inter-route improvement, intra-route improvement, guided search, tabu search, etc.) the solver is executing. The solvers compute improvements to the set of initial solutions by at least executing the search algorithm. In various embodiments, at block B404, the system executing the method 400 generates candidates (e.g., potential solutions that may be optimal relative to the starting solution).

At block B406, in an embodiment, the system executing the method 400 obtains solutions generated by the solvers. In one example, the solvers generate solutions that are maintained in a data structure and sorted based at least in part on a savings value computed for the solutions. At block B408, in an embodiment, the system executing the method 400 determines if the solutions satisfy the set of constraints. As described above, the constraints include delivery times, vehicle capacity, wait time, and other constraints, the system executing the method 400, for example, determines if a particular solution complies with the constraints. In addition, in an embodiment, the constraints may include hard constraints that may not be violated and soft constraints which may be violated if certain conditions are met.

If the particular solution and/or improvement does not satisfy the constraints, the system executing the method 400, continues to block B410 and the solution is rejected. In one example, the rejected solution and/or improvement is not assigned to a solver. However, if the particular solution and/or improvement does satisfy the constraints, the system executing the method 400, continues to block B412, and determines if the budget is exceeded. In one example, the solvers are allowed to execute for an interval of time before a solution is to be provided. If the budget is not exceeded, the system executing the method 400 returns to block B404 and additional solutions and/or improvements are calculated.

However, at block B412, if the budget is exceeded, the system executing the method 400 continues to block B414 and an optimal solution is provided. In one example, the optimal solution includes the solution with the greatest objective function value. In an embodiment, a savings value is used to determine improvements (e.g., one or more candidates) to be applied to the current solution which modifies (e.g., improves) a value computed using the objective function. In this manner, the solution with the best object function (e.g., minimum value or maximum value based at least in part on the combinatorial optimization problem being solved) is chosen as the optimal solution, in accordance with an embodiment. Although, the term optimal solution is used, the optimal solution is not guaranteed, by the nature of NP-hard problems, to be the best possible solution. For example, the result of the method 400 (e.g., the selected optimal solution) is an approximation of the optimal solution which is as close as possible to that value (e.g., the actual optimal solution) that is obtained within the execution budget based at least in part on the objective function. In various embodiments, the plurality of solvers executing in parallel generate a plurality of distinct solution that satisfy the constraints, the plurality of solutions minimizes and/or maximizes one or more features of the combinatorial optimization problem. In one example, the solutions minimize a total distance traveled in a vehicle routing problem. In another example, the solutions maximized an amount of utilized space in a bin packing problem. In another example the number of vehicles required to perform a set of tasks is minimized. In various embodiments, the method 400 can be used to generate a plurality of feasible solutions of the combinatorial optimization problem, at least one solution being better and/or an improvement relative to the other solutions.

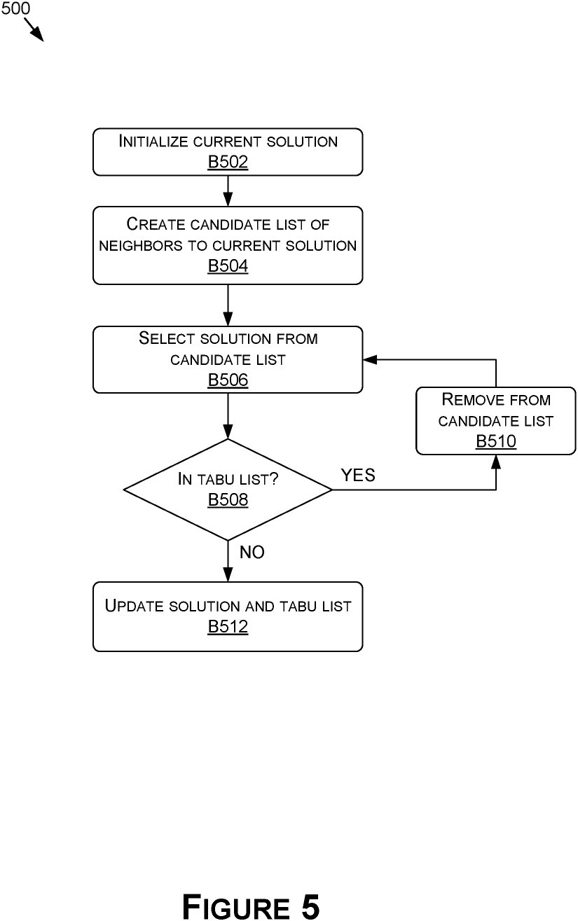

FIG. 5 is a flow diagram showing a method 500 for escaping a local minimum utilizing a plurality of solvers executed by PPUs in parallel, in accordance with some embodiments of the present disclosure. In various embodiments, the system executing the method 500 at block B502 initializes the current solution. As described above, the solvers are assigned initial solutions to which improvements are determined and applied, thereby generating new solutions, in accordance with at least one embodiment. The solution being processed by the solver at any time T, in at least one embodiment, is considered the current solution at time T.

At block B504, the system executing the method 500 creates a candidate list of neighbor solutions to the current solution B504. In various embodiments, neighbor solutions in the search space include solutions separated by a single change and/or modification in one state variable of bounded magnitude. Neighbor solutions in a vehicle routing problem, may include, for example and without limitation, routes that are separated by a single change to the route. In an embodiment, elements of the current solution are randomized to generate candidate solutions (e.g., solutions which may be an improvement and/or worsening to the current solution). In another example, inter-route improvements and/or intra-route improvements are determined and included in the candidate list. At block B506, the system executing the method 500, selects a solution from the candidate list to evaluate. In one example, the candidate list contains diversified (e.g. worsening modification to the current solution based at least in part on a savings value) solutions and the system executing the method 500 selects a candidate from the list. In another example, the candidate list contains intensified (e.g., improving modification to the current solution based at least in part on a savings value) solutions which is sorted based at least in part on a savings value and the system executing the method 500 selects the candidate based at least in part on the savings value

At block B508, the system executing the method 500, determines if the candidate solution is included in a penalty or forbidden list. In various embodiments, the penalty list includes a list of local minima and/or maxima, and/or a list of penalized improvements (e.g., modifications to solutions) in the search space. As such, in various embodiments, the penalty list is used to increase the amount (e.g., fraction) of the search space evaluated by the solvers. If the candidate is in the penalty list, the system executing the method 500 continues to block B510 and removes the candidate from the list. However, if the candidate is not on the penalty list, the system executing the method 500 continues to block B512 and updates the solution and the penalty list. For example, the solution is assigned to a solver and recorded in the penalty list. In various embodiments, the method 500 is executed until an execution budget is exceed. In yet other embodiments, the method 500 is executed until a status of the solver is modified. For example, when the status of a particular solver is set to “tabu search,” the solver causes the method 500 to be executed until the status of the particular solver is modified.

### Parallel Processing Architecture

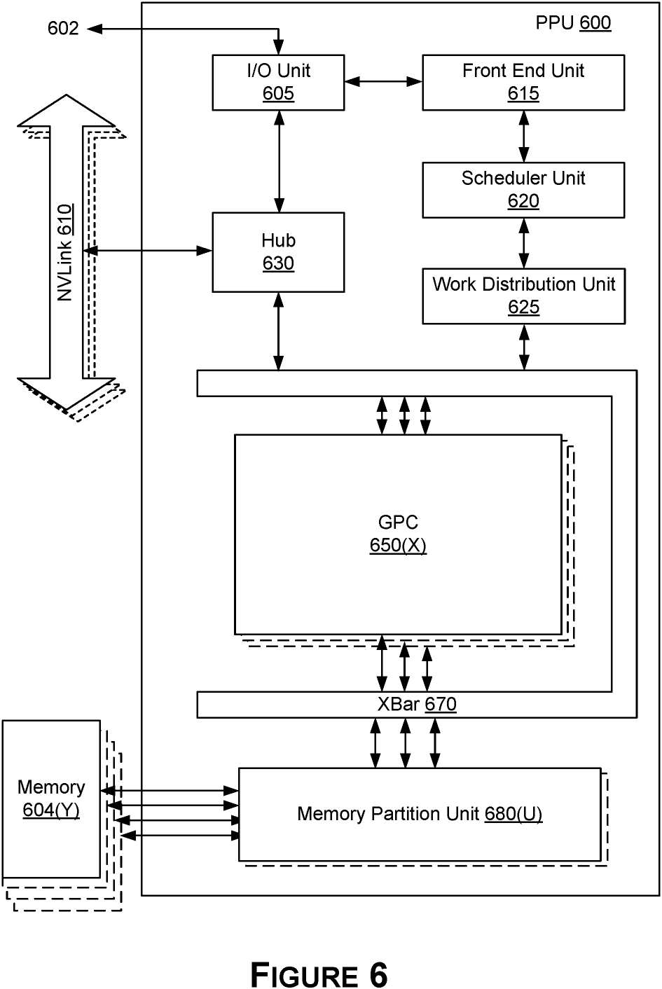

FIG. 6 illustrates a parallel processing unit (PPU) 600, in accordance with an embodiment. In an embodiment, the PPU 600 is a multi-threaded processor that is implemented on one or more integrated circuit devices. The PPU 600 is a latency hiding architecture designed to process many threads in parallel. A thread (e.g., a thread of execution) is an instantiation of a set of instructions configured to be executed by the PPU 600. In an embodiment, the PPU 600 is a graphics processing unit (GPU) configured to implement a graphics rendering pipeline for processing three-dimensional (3D) graphics data in order to generate two-dimensional (2D) image data for display on a display device such as a liquid crystal display (LCD) device. In other embodiments, the PPU 600 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more PPUs 600 may be configured to accelerate thousands of High Performance Computing (HPC), data center, and machine learning applications. The PPU 600 may be configured to accelerate numerous deep learning systems and applications including autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 6, the PPU 600 includes an Input/Output (I/O) unit 605, a front end unit 615, a scheduler unit 620, a work distribution unit 625, a hub 630, a crossbar (Xbar) 670, one or more general processing clusters (GPCs) 650, and one or more partition units 680. The PPU 600 may be connected to a host processor or other PPUs 600 via one or more high-speed NVLink 610 interconnect. The PPU 600 may be connected to a host processor or other peripheral devices via an interconnect 602. The PPU 600 may also be connected to a local memory comprising a number of memory devices 604. In an embodiment, the local memory may comprise a number of dynamic random access memory (DRAM) devices. The DRAM devices may be configured as a high-bandwidth memory (HBM) subsystem, with multiple DRAM dies stacked within each device.

The NVLink 610 interconnect enables systems to scale and include one or more PPUs 600 combined with one or more CPUs, supports cache coherence between the PPUs 600 and CPUs, and CPU mastering. Data and/or commands may be transmitted by the NVLink 610 through the hub 630 to/from other units of the PPU 600 such as one or more copy engines, a video encoder, a video decoder, a power management unit, etc. (not explicitly shown). The NVLink 610 is described in more detail in conjunction with FIG. 5B.

The I/O unit 605 is configured to transmit and receive communications (e.g., commands, data, etc.) from a host processor (not shown) over the interconnect 602. The I/O unit 605 may communicate with the host processor directly via the interconnect 602 or through one or more intermediate devices such as a memory bridge. In an embodiment, the I/O unit 605 may communicate with one or more other processors, such as one or more the PPUs 600 via the interconnect 602. In an embodiment, the I/O unit 605 implements a Peripheral Component Interconnect Express (PCIe) interface for communications over a PCIe bus and the interconnect 602 is a PCIe bus. In alternative embodiments, the I/O unit 605 may implement other types of well-known interfaces for communicating with external devices.

The I/O unit 605 decodes packets received via the interconnect 602. In an embodiment, the packets represent commands configured to cause the PPU 600 to perform various operations. The I/O unit 605 transmits the decoded commands to various other units of the PPU 600 as the commands may specify. For example, some commands may be transmitted to the front end unit 615. Other commands may be transmitted to the hub 630 or other units of the PPU 600 such as one or more copy engines, a video encoder, a video decoder, a power management unit, etc. (not explicitly shown). In other words, the I/O unit 605 is configured to route communications between and among the various logical units of the PPU 600.

In an embodiment, a program executed by the host processor encodes a command stream in a buffer that provides workloads to the PPU 600 for processing. A workload may comprise several instructions and data to be processed by those instructions. The buffer is a region in a memory that is accessible (e.g., read/write) by both the host processor and the PPU 600. For example, the I/O unit 605 may be configured to access the buffer in a system memory connected to the interconnect 602 via memory requests transmitted over the interconnect 602. In an embodiment, the host processor writes the command stream to the buffer and then transmits a pointer to the start of the command stream to the PPU 600. The front end unit 615 receives pointers to one or more command streams. The front end unit 615 manages the one or more streams, reading commands from the streams and forwarding commands to the various units of the PPU 600.

The front end unit 615 is coupled to a scheduler unit 620 that configures the various GPCs 650 to process tasks defined by the one or more streams. The scheduler unit 620 is configured to track state information related to the various tasks managed by the scheduler unit 620. The state may indicate which GPC 650 a task is assigned to, whether the task is active or inactive, a priority level associated with the task, and so forth. The scheduler unit 620 manages the execution of a plurality of tasks on the one or more GPCs 650.

The scheduler unit 620 is coupled to a work distribution unit 625 that is configured to dispatch tasks for execution on the GPCs 650. The work distribution unit 625 may track a number of scheduled tasks received from the scheduler unit 620. In an embodiment, the work distribution unit 625 manages a pending task pool and an active task pool for each of the GPCs 650. The pending task pool may comprise a number of slots (e.g., 32 slots) that contain tasks assigned to be processed by a particular GPC 650. The active task pool may comprise a number of slots (e.g., 4 slots) for tasks that are actively being processed by the GPCs 650. As a GPC 650 finishes the execution of a task, that task is evicted from the active task pool for the GPC 650 and one of the other tasks from the pending task pool is selected and scheduled for execution on the GPC 650. If an active task has been idle on the GPC 650, such as while waiting for a data dependency to be resolved, then the active task may be evicted from the GPC 650 and returned to the pending task pool while another task in the pending task pool is selected and scheduled for execution on the GPC 650.

The work distribution unit 625 communicates with the one or more GPCs 650 via XBar 670. The XBar 670 is an interconnect network that couples many of the units of the PPU 600 to other units of the PPU 600. For example, the XBar 670 may be configured to couple the work distribution unit 625 to a particular GPC 650. Although not shown explicitly, one or more other units of the PPU 600 may also be connected to the XBar 670 via the hub 630.

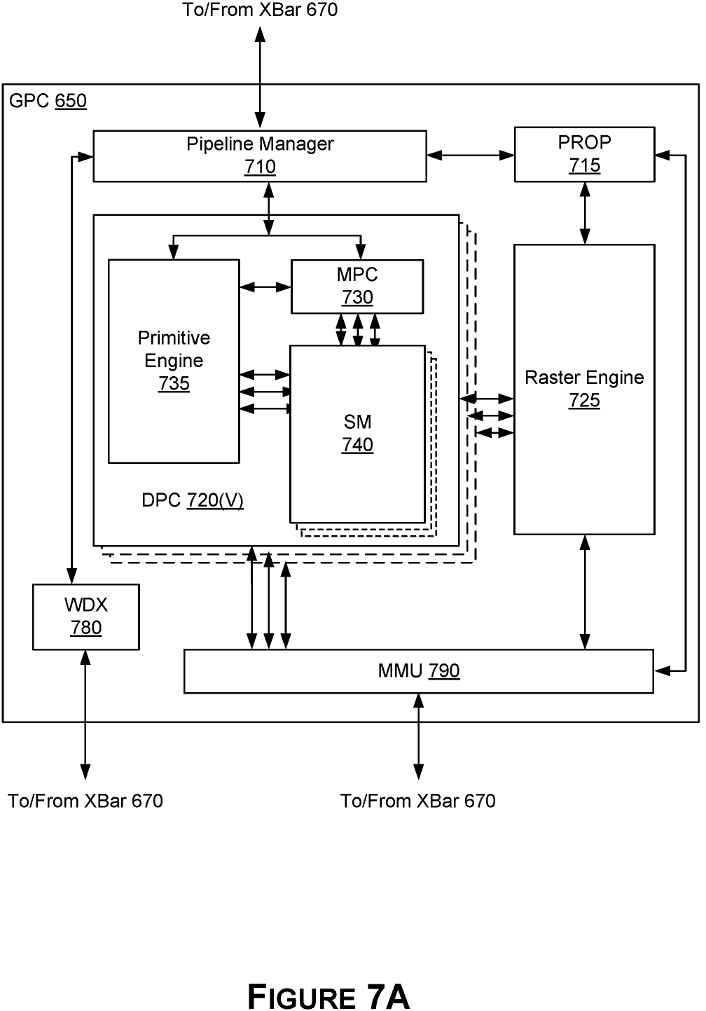

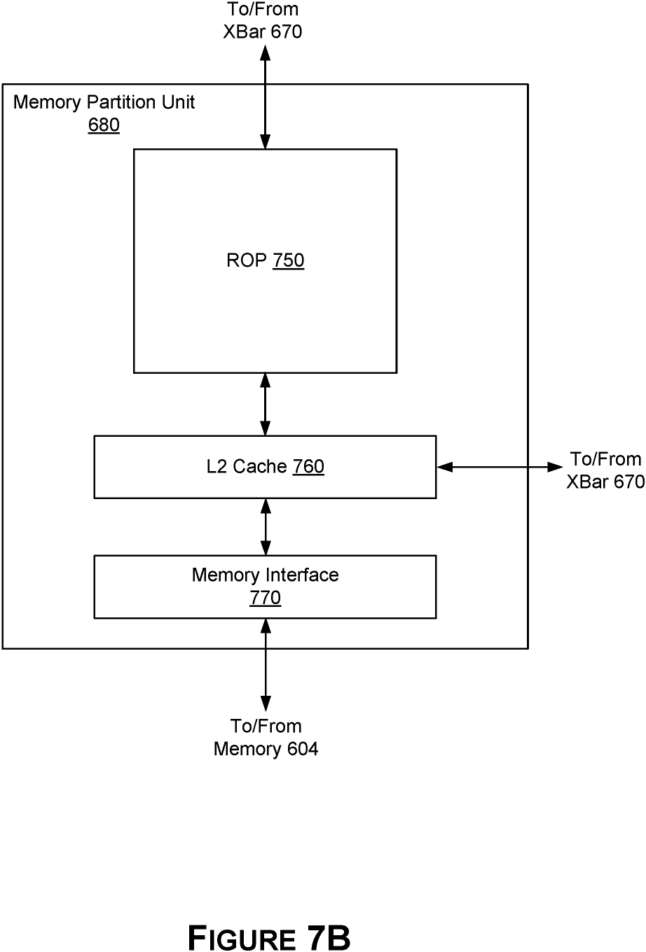

The tasks are managed by the scheduler unit 620 and dispatched to a GPC 650 by the work distribution unit 625. The GPC 650 is configured to process the task and generate results. The results may be consumed by other tasks within the GPC 650, routed to a different GPC 650 via the XBar 670, or stored in the memory 604. The results can be written to the memory 604 via the partition units 680, which implement a memory interface for reading and writing data to/from the memory 604. The results can be transmitted to another PPU 604 or CPU via the NVLink 610. In an embodiment, the PPU 600 includes a number U of partition units 680 that is equal to the number of separate and distinct memory devices 604 coupled to the PPU 600. A partition unit 680 will be described in more detail below in conjunction with FIG. 7B.

In an embodiment, a host processor executes a driver kernel that implements an application programming interface (API) that enables one or more applications executing on the host processor to schedule operations for execution on the PPU 600. In an embodiment, multiple compute applications are simultaneously executed by the PPU 600 and the PPU 600 provides isolation, quality of service (QoS), and independent address spaces for the multiple compute applications. An application may generate instructions (e.g., API calls) that cause the driver kernel to generate one or more tasks for execution by the PPU 600. The driver kernel outputs tasks to one or more streams being processed by the PPU 600. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. Threads and cooperating threads are described in more detail in conjunction with FIG. 8A.

FIG. 7A illustrates a GPC 650 of the PPU 600 of FIG. 6, in accordance with an embodiment. As shown in FIG. 7A, each GPC 650 includes a number of hardware units for processing tasks. In an embodiment, each GPC 650 includes a pipeline manager 710, a pre-raster operations unit (PROP) 715, a raster engine 725, a work distribution crossbar (WDX) 780, a memory management unit (MMU) 790, and one or more Data Processing Clusters (DPCs) 720. It will be appreciated that the GPC 650 of FIG. 7A may include other hardware units in lieu of or in addition to the units shown in FIG. 7A.

In an embodiment, the operation of the GPC 650 is controlled by the pipeline manager 710. The pipeline manager 710 manages the configuration of the one or more DPCs 720 for processing tasks allocated to the GPC 650. In an embodiment, the pipeline manager 710 may configure at least one of the one or more DPCs 720 to implement at least a portion of a graphics rendering pipeline. For example, a DPC 720 may be configured to execute a vertex shader program on the programmable streaming multiprocessor (SM) 740. The pipeline manager 710 may also be configured to route packets received from the work distribution unit 625 to the appropriate logical units within the GPC 650. For example, some packets may be routed to fixed function hardware units in the PROP 715 and/or raster engine 725 while other packets may be routed to the DPCs 720 for processing by the primitive engine 735 or the SM 740. In an embodiment, the pipeline manager 710 may configure at least one of the one or more DPCs 720 to implement a neural network model and/or a computing pipeline.

The PROP unit 715 is configured to route data generated by the raster engine 725 and the DPCs 720 to a Raster Operations (ROP) unit, described in more detail in conjunction with FIG. 7B. The PROP unit 715 may also be configured to perform optimizations for color blending, organize pixel data, perform address translations, and the like.

The raster engine 725 includes a number of fixed function hardware units configured to perform various raster operations. In an embodiment, the raster engine 725 includes a setup engine, a coarse raster engine, a culling engine, a clipping engine, a fine raster engine, and a tile coalescing engine. The setup engine receives transformed vertices and generates plane equations associated with the geometric primitive defined by the vertices. The plane equations are transmitted to the coarse raster engine to generate coverage information (e.g., an x,y coverage mask for a tile) for the primitive. The output of the coarse raster engine is transmitted to the culling engine where fragments associated with the primitive that fail a z-test are culled, and transmitted to a clipping engine where fragments lying outside a viewing frustum are clipped. Those fragments that survive clipping and culling may be passed to the fine raster engine to generate attributes for the pixel fragments based on the plane equations generated by the setup engine. The output of the raster engine 725 comprises fragments to be processed, for example, by a fragment shader implemented within a DPC 720.

Each DPC 720 included in the GPC 650 includes an M-Pipe Controller (MPC) 730, a primitive engine 735, and one or more SMs 740. The MPC 730 controls the operation of the DPC 720, routing packets received from the pipeline manager 710 to the appropriate units in the DPC 720. For example, packets associated with a vertex may be routed to the primitive engine 735, which is configured to fetch vertex attributes associated with the vertex from the memory 604. In contrast, packets associated with a shader program may be transmitted to the SM 740.

The SM 740 comprises a programmable streaming processor that is configured to process tasks represented by a number of threads. Each SM 740 is multi-threaded and configured to execute a plurality of threads (e.g., 32 threads) from a particular group of threads concurrently. In an embodiment, the SM 740 implements a SIMD (Single-Instruction, Multiple-Data) architecture where each thread in a group of threads (e.g., a warp) is configured to process a different set of data based on the same set of instructions. All threads in the group of threads execute the same instructions. In another embodiment, the SM 740 implements a SIMT (Single-Instruction, Multiple Thread) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The SM 740 will be described in more detail below in conjunction with FIG. 8A.

The MMU 790 provides an interface between the GPC 650 and the partition unit 680. The MMU 790 may provide translation of virtual addresses into physical addresses, memory protection, and arbitration of memory requests. In an embodiment, the MMU 790 provides one or more translation lookaside buffers (TLBs) for performing translation of virtual addresses into physical addresses in the memory 604.

FIG. 7B illustrates a memory partition unit 680 of the PPU 600 of FIG. 6, in accordance with an embodiment. As shown in FIG. 7B, the memory partition unit 680 includes a Raster Operations (ROP) unit 750, a level two (L2) cache 760, and a memory interface 770. The memory interface 770 is coupled to the memory 604. Memory interface 770 may implement 32, 64, 128, 1024-bit data buses, or the like, for high-speed data transfer. In an embodiment, the PPU 600 incorporates U memory interfaces 770, one memory interface 770 per pair of partition units 680, where each pair of partition units 680 is connected to a corresponding memory device 604. For example, PPU 600 may be connected to up to Y memory devices 604, such as high bandwidth memory stacks or graphics double-data-rate, version 5, synchronous dynamic random access memory, or other types of persistent storage.

In an embodiment, the memory interface 770 implements an HBM2 memory interface and Y equals half U. In an embodiment, the HBM2 memory stacks are located on the same physical package as the PPU 600, providing substantial power and area savings compared with conventional GDDR5 SDRAM systems. In an embodiment, each HBM2 stack includes four memory dies and Y equals 4, with HBM2 stack including two 128-bit channels per die for a total of 8 channels and a data bus width of 1024 bits.

In an embodiment, the memory 604 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where PPUs 600 process very large datasets and/or run applications for extended periods.

In an embodiment, the PPU 600 implements a multi-level memory hierarchy. In an embodiment, the memory partition unit 680 supports a unified memory to provide a single unified virtual address space for CPU and PPU 600 memory, enabling data sharing between virtual memory systems. In an embodiment the frequency of accesses by a PPU 600 to memory located on other processors is traced to ensure that memory pages are moved to the physical memory of the PPU 600 that is accessing the pages more frequently. In an embodiment, the NVLink 610 supports address translation services allowing the PPU 600 to directly access a CPU’s page tables and providing full access to CPU memory by the PPU 600.

In an embodiment, copy engines transfer data between multiple PPUs 600 or between PPUs 600 and CPUs. The copy engines can generate page faults for addresses that are not mapped into the page tables. The memory partition unit 680 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 604 or other system memory may be fetched by the memory partition unit 680 and stored in the L2 cache 760, which is located on-chip and is shared between the various GPCs 650. As shown, each memory partition unit 680 includes a portion of the L2 cache 760 associated with a corresponding memory device 604. Lower level caches may then be implemented in various units within the GPCs 650. For example, each of the SMs 740 may implement a level one (L1) cache. The L1 cache is private memory that is dedicated to a particular SM 740. Data from the L2 cache 760 may be fetched and stored in each of the L1 caches for processing in the functional units of the SMs 740. The L2 cache 760 is coupled to the memory interface 770 and the XBar 670.

The ROP unit 750 performs graphics raster operations related to pixel color, such as color compression, pixel blending, and the like. The ROP unit 750 also implements depth testing in conjunction with the raster engine 725, receiving a depth for a sample location associated with a pixel fragment from the culling engine of the raster engine 725. The depth is tested against a corresponding depth in a depth buffer for a sample location associated with the fragment. If the fragment passes the depth test for the sample location, then the ROP unit 750 updates the depth buffer and transmits a result of the depth test to the raster engine 725. It will be appreciated that the number of partition units 680 may be different than the number of GPCs 650 and, therefore, each ROP unit 750 may be coupled to each of the GPCs 650. The ROP unit 750 tracks packets received from the different GPCs 650 and determines which GPC 650 that a result generated by the ROP unit 750 is routed to through the Xbar 670. Although the ROP unit 750 is included within the memory partition unit 680 in FIG. 7B, in other embodiment, the ROP unit 750 may be outside of the memory partition unit 680. For example, the ROP unit 750 may reside in the GPC 650 or another unit.

FIG. 8A illustrates the streaming multi-processor 740 of FIG. 7A, in accordance with an embodiment. As shown in FIG. 8A, the SM 740 includes an instruction cache 805, one or more scheduler units 810, a register file 820, one or more processing cores 850, one or more special function units (SFUs) 852, one or more load/store units (LSUs) 854, an interconnect network 880, a shared memory/L1 cache 870.

As described above, the work distribution unit 625 dispatches tasks for execution on the GPCs 650 of the PPU 600. The tasks are allocated to a particular DPC 720 within a GPC 650 and, if the task is associated with a shader program, the task may be allocated to an SM 740. The scheduler unit 810 receives the tasks from the work distribution unit 625 and manages instruction scheduling for one or more thread blocks assigned to the SM 740. The scheduler unit 810 schedules thread blocks for execution as warps of parallel threads, where each thread block is allocated at least one warp. In an embodiment, each warp executes 32 threads. The scheduler unit 810 may manage a plurality of different thread blocks, allocating the warps to the different thread blocks and then dispatching instructions from the plurality of different cooperative groups to the various functional units (e.g., cores 850, SFUs 852, and LSUs 854) during each clock cycle.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads() function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

A dispatch unit 815 is configured to transmit instructions to one or more of the functional units. In the embodiment, the scheduler unit 810 includes two dispatch units 815 that enable two different instructions from the same warp to be dispatched during each clock cycle. In alternative embodiments, each scheduler unit 810 may include a single dispatch unit 815 or additional dispatch units 815.

Each SM 740 includes a register file 820 that provides a set of registers for the functional units of the SM 740. In an embodiment, the register file 820 is divided between each of the functional units such that each functional unit is allocated a dedicated portion of the register file 820. In another embodiment, the register file 820 is divided between the different warps being executed by the SM 740. The register file 820 provides temporary storage for operands connected to the data paths of the functional units.

Each SM 740 comprises L processing cores 850. In an embodiment, the SM 740 includes a large number (e.g., 128, etc.) of distinct processing cores 850. Each core 850 may include a fully-pipelined, single-precision, double-precision, and/or mixed precision processing unit that includes a floating point arithmetic logic unit and an integer arithmetic logic unit. In an embodiment, the floating point arithmetic logic units implement the IEEE 754-2008 standard for floating point arithmetic. In an embodiment, the cores 850 include 64 single-precision (32-bit) floating point cores, 64 integer cores, 32 double-precision (64-bit) floating point cores, and 8 tensor cores.

Tensor cores configured to perform matrix operations, and, in an embodiment, one or more tensor cores are included in the cores 850. In particular, the tensor cores are configured to perform deep learning matrix arithmetic, such as convolution operations for neural network training and inferencing. In an embodiment, each tensor core operates on a 4x4 matrix and performs a matrix multiply and accumulate operation D=AxB+C, where A, B, C, and D are 4x4 matrices.

In an embodiment, the matrix multiply inputs A and B are 16-bit floating point matrices, while the accumulation matrices C and D may be 16-bit floating point or 32-bit floating point matrices. Tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4x4x4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16x16 size matrices spanning all 32 threads of the warp.

Each SM 740 also comprises M SFUs 852 that perform special functions (e.g., attribute evaluation, reciprocal square root, and the like). In an embodiment, the SFUs 852 may include a tree traversal unit configured to traverse a hierarchical tree data structure. In an embodiment, the SFUs 852 may include texture unit configured to perform texture map filtering operations. In an embodiment, the texture units are configured to load texture maps (e.g., a 2D array of texels) from the memory 604 and sample the texture maps to produce sampled texture values for use in shader programs executed by the SM 740. In an embodiment, the texture maps are stored in the shared memory/L1 cache 770. The texture units implement texture operations such as filtering operations using mip-maps (e.g., texture maps of varying levels of detail). In an embodiment, each SM 640 includes two texture units.

Each SM 740 also comprises NLSUs 854 that implement load and store operations between the shared memory/L1 cache 870 and the register file 820. Each SM 740 includes an interconnect network 880 that connects each of the functional units to the register file 820 and the LSU 854 to the register file 820, shared memory/ L1 cache 870. In an embodiment, the interconnect network 880 is a crossbar that can be configured to connect any of the functional units to any of the registers in the register file 820 and connect the LSUs 854 to the register file and memory locations in shared memory/L1 cache 870.

The shared memory/L1 cache 870 is an array of on-chip memory that allows for data storage and communication between the SM 740 and the primitive engine 735 and between threads in the SM 740. In an embodiment, the shared memory/L1 cache 870 comprises 128 KB of storage capacity and is in the path from the SM 740 to the partition unit 680. The shared memory/L1 cache 870 can be used to cache reads and writes. One or more of the shared memory/L1 cache 870, L2 cache 760, and memory 604 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory/L1 cache 870 enables the shared memory/L1 cache 870 to function as a high-throughput conduit for streaming data while simultaneously providing high-bandwidth and low-latency access to frequently reused data.

When configured for general purpose parallel computation, a simpler configuration can be used compared with graphics processing. Specifically, the fixed function graphics processing units shown in FIG. 6, are bypassed, creating a much simpler programming model. In the general purpose parallel computation configuration, the work distribution unit 625 assigns and distributes blocks of threads directly to the DPCs 720. The threads in a block execute the same program, using a unique thread ID in the calculation to ensure each thread generates unique results, using the SM 740 to execute the program and perform calculations, shared memory/L1 cache 870 to communicate between threads, and the LSU 854 to read and write global memory through the shared memory/L1 cache 870 and the memory partition unit 680. When configured for general purpose parallel computation, the SM 740 can also write commands that the scheduler unit 620 can use to launch new work on the DPCs 720.

The PPU 600 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the PPU 600 is embodied on a single semiconductor substrate. In another embodiment, the PPU 600 is included in a system-on-a-chip (SoC) along with one or more other devices such as additional PPUs 600, the memory, a reduced instruction set computer (RISC) CPU, a memory management unit (MMU), a digital-to-analog converter (DAC), and the like.

In an embodiment, the PPU 600 may be included on a graphics card that includes one or more memory devices 604. The graphics card may be configured to interface with a PCIe slot on a motherboard of a desktop computer. In yet another embodiment, the PPU 600 may be an integrated graphics processing unit (iGPU) or parallel processor included in the chipset of the motherboard.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 8B is a conceptual diagram of a processing system 800 implemented using the PPU 600 of FIG. 6, in accordance with an embodiment. The processing system 800 includes a CPU 830, switch 810, and multiple PPUs 600 each and respective memories 604. The NVLink 610 provides high-speed communication links between each of the PPUs 600. Although a particular number of NVLink 610 and interconnect 602 connections are illustrated in FIG. 8B, the number of connections to each PPU 600 and the CPU 830 may vary. The switch 810 interfaces between the interconnect 602 and the CPU 830. The PPUs 600, memories 604, and NVLinks 610 may be situated on a single semiconductor platform to form a parallel processing module 825. In an embodiment, the switch 810 supports two or more protocols to interface between various different connections and/or links.

In another embodiment (not shown), the NVLink 610 provides one or more high-speed communication links between each of the PPUs 600 and the CPU 830 and the switch 810 interfaces between the interconnect 602 and each of the PPUs 600. The PPUs 600, memories 604, and interconnect 602 may be situated on a single semiconductor platform to form a parallel processing module 825. In yet another embodiment (not shown), the interconnect 602 provides one or more communication links between each of the PPUs 600 and the CPU 830 and the switch 810 interfaces between each of the PPUs 600 using the NVLink 610 to provide one or more high-speed communication links between the PPUs 600. In another embodiment (not shown), the NVLink 610 provides one or more high-speed communication links between the PPUs 600 and the CPU 830 through the switch 810. In yet another embodiment (not shown), the interconnect 602 provides one or more communication links between each of the PPUs 600 directly. One or more of the NVLink 610 high-speed communication links may be implemented as a physical NVLink interconnect or either an on-chip or on-die interconnect using the same protocol as the NVLink 610.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 825 may be implemented as a circuit board substrate and each of the PPUs 600 and/or memories 604 may be packaged devices. In an embodiment, the CPU 830, switch 810, and the parallel processing module 825 are situated on a single semiconductor platform.

In an embodiment, the signaling rate of each NVLink 610 is 20 to 25 Gigabits/second and each PPU 600 includes six NVLink 610 interfaces (as shown in FIG. 8B, five NVLink 610 interfaces are included for each PPU 600). Each NVLink 610 provides a data transfer rate of 25 Gigabytes/second in each direction, with six links providing 600 Gigabytes/second. The NVLinks 610 can be used exclusively for PPU-to-PPU communication as shown in FIG. 8B, or some combination of PPU-to-PPU and PPU-to-CPU, when the CPU 830 also includes one or more NVLink 610 interfaces.

In an embodiment, the NVLink 610 allows direct load/store/atomic access from the CPU 830 to each PPU’s 600 memory 604. In an embodiment, the NVLink 610 supports coherency operations, allowing data read from the memories 604 to be stored in the cache hierarchy of the CPU 830, reducing cache access latency for the CPU 830. In an embodiment, the NVLink 610 includes support for Address Translation Services (ATS), allowing the PPU 600 to directly access page tables within the CPU 830. One or more of the NVLinks 610 may also be configured to operate in a low-power mode.

FIG. 8C illustrates an exemplary system 865 in which the various architecture and/or functionality of the various previous embodiments may be implemented.

As shown, a system 865 is provided including at least one central processing unit 830 that is connected to a communication bus 875. The communication bus 875 may be implemented using any suitable protocol, such as PCI (Peripheral Component Interconnect), PCI-Express, AGP (Accelerated Graphics Port), HyperTransport, or any other bus or point-to-point communication protocol(s). The system 865 also includes a main memory 840. Control logic (software) and data are stored in the main memory 840 which may take the form of random access memory (RAM).

The system 865 also includes input devices 860, the parallel processing system 825, and display devices 845, e.g. a conventional CRT (cathode ray tube), LCD (liquid crystal display), LED (light emitting diode), plasma display or the like. User input may be received from the input devices 860, e.g., keyboard, mouse, touchpad, microphone, and the like. Each of the foregoing modules and/or devices may even be situated on a single semiconductor platform to form the system 865. Alternately, the various modules may also be situated separately or in various combinations of semiconductor platforms per the desires of the user.

Further, the system 865 may be coupled to a network (e.g., a telecommunications network, local area network (LAN), wireless network, wide area network (WAN) such as the Internet, peer-to-peer network, cable network, or the like) through a network interface 835 for communication purposes.

The system 865 may also include a secondary storage (not shown). The secondary storage 910 includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 840 and/or the secondary storage. Such computer programs, when executed, enable the system 865 to perform various functions. The memory 840, the storage, and/or any other storage are possible examples of computer-readable media.

The architecture and/or functionality of the various previous figures may be implemented in the context of a general computer system, a circuit board system, a game console system dedicated for entertainment purposes, an application-specific system, and/or any other desired system. For example, the system 865 may take the form of a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, a mobile phone device, a television, workstation, game consoles, embedded system, and/or any other type of logic.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Graphics Processing Pipeline

In an embodiment, the PPU 600 comprises a graphics processing unit (GPU). The PPU 600 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 600 can be configured to process the graphics primitives to generate a frame buffer (e.g., pixel data for each of the pixels of the display).

An application writes model data for a scene (e.g., a collection of vertices and attributes) to a memory such as a system memory or memory 604. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the SMs 740 of the PPU 600 including one or more of a vertex shader, hull shader, domain shader, geometry shader, and a pixel shader. For example, one or more of the SMs 740 may be configured to execute a vertex shader program that processes a number of vertices defined by the model data. In an embodiment, the different SMs 740 may be configured to execute different shader programs concurrently. For example, a first subset of SMs 740 may be configured to execute a vertex shader program while a second subset of SMs 740 may be configured to execute a pixel shader program. The first subset of SMs 740 processes vertex data to produce processed vertex data and writes the processed vertex data to the L2 cache 760 and/or the memory 604. After the processed vertex data is rasterized (e.g., transformed from three-dimensional data into two-dimensional data in screen space) to produce fragment data, the second subset of SMs 740 executes a pixel shader to produce processed fragment data, which is then blended with other processed fragment data and written to the frame buffer in memory 604. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

FIG. 9 is a conceptual diagram of a graphics processing pipeline 900 implemented by the PPU 600 of FIG. 6, in accordance with an embodiment. The graphics processing pipeline 900 is an abstract flow diagram of the processing steps implemented to generate 2D computer-generated images from 3D geometry data. As is well-known, pipeline architectures may perform long latency operations more efficiently by splitting up the operation into a plurality of stages, where the output of each stage is coupled to the input of the next successive stage. Thus, the graphics processing pipeline 900 receives input data 901 that is transmitted from one stage to the next stage of the graphics processing pipeline 900 to generate output data 902. In an embodiment, the graphics processing pipeline 900 may represent a graphics processing pipeline defined by the OpenGL® API. As an option, the graphics processing pipeline 900 may be implemented in the context of the functionality and architecture of the previous FIGS. and/or any subsequent FIGS.

As shown in FIG. 9, the graphics processing pipeline 900 comprises a pipeline architecture that includes a number of stages. The stages include, but are not limited to, a data assembly stage 910, a vertex shading stage 920, a primitive assembly stage 930, a geometry shading stage 940, a viewport scale, cull, and clip (VSCC) stage 950, a rasterization stage 960, a fragment shading stage 970, and a raster operations stage 980. In an embodiment, the input data 901 comprises commands that configure the processing units to implement the stages of the graphics processing pipeline 900 and geometric primitives (e.g., points, lines, triangles, quads, triangle strips or fans, etc.) to be processed by the stages. The output data 902 may comprise pixel data (e.g., color data) that is copied into a frame buffer or other type of surface data structure in a memory.

The data assembly stage 910 receives the input data 901 that specifies vertex data for high-order surfaces, primitives, or the like. The data assembly stage 910 collects the vertex data in a temporary storage or queue, such as by receiving a command from the host processor that includes a pointer to a buffer in memory and reading the vertex data from the buffer. The vertex data is then transmitted to the vertex shading stage 920 for processing.

The vertex shading stage 920 processes vertex data by performing a set of operations (e.g., a vertex shader or a program) once for each of the vertices. Vertices may be, e.g., specified as a 4-coordinate vector (e.g., <x, y, z, w>) associated with one or more vertex attributes (e.g., color, texture coordinates, surface normal, etc.). The vertex shading stage 920 may manipulate individual vertex attributes such as position, color, texture coordinates, and the like. In other words, the vertex shading stage 920 performs operations on the vertex coordinates or other vertex attributes associated with a vertex. Such operations commonly including lighting operations (e.g., modifying color attributes for a vertex) and transformation operations (e.g., modifying the coordinate space for a vertex). For example, vertices may be specified using coordinates in an object-coordinate space, which are transformed by multiplying the coordinates by a matrix that translates the coordinates from the object-coordinate space into a world space or a normalized-device-coordinate (NCD) space. The vertex shading stage 920 generates transformed vertex data that is transmitted to the primitive assembly stage 930.

The primitive assembly stage 930 collects vertices output by the vertex shading stage 920 and groups the vertices into geometric primitives for processing by the geometry shading stage 940. For example, the primitive assembly stage 930 may be configured to group every three consecutive vertices as a geometric primitive (e.g., a triangle) for transmission to the geometry shading stage 940. In some embodiments, specific vertices may be reused for consecutive geometric primitives (e.g., two consecutive triangles in a triangle strip may share two vertices). The primitive assembly stage 930 transmits geometric primitives (e.g., a collection of associated vertices) to the geometry shading stage 940.

The geometry shading stage 940 processes geometric primitives by performing a set of operations (e.g., a geometry shader or program) on the geometric primitives. Tessellation operations may generate one or more geometric primitives from each geometric primitive. In other words, the geometry shading stage 940 may subdivide each geometric primitive into a finer mesh of two or more geometric primitives for processing by the rest of the graphics processing pipeline 900. The geometry shading stage 940 transmits geometric primitives to the viewport SCC stage 950.

In an embodiment, the graphics processing pipeline 900 may operate within a streaming multiprocessor and the vertex shading stage 920, the primitive assembly stage 930, the geometry shading stage 940, the fragment shading stage 970, and/or hardware/software associated therewith, may sequentially perform processing operations. Once the sequential processing operations are complete, in an embodiment, the viewport SCC stage 950 may utilize the data. In an embodiment, primitive data processed by one or more of the stages in the graphics processing pipeline 900 may be written to a cache (e.g. L1 cache, a vertex cache, etc.). In this case, in an embodiment, the viewport SCC stage 950 may access the data in the cache. In an embodiment, the viewport SCC stage 950 and the rasterization stage 960 are implemented as fixed function circuitry.

The viewport SCC stage 950 performs viewport scaling, culling, and clipping of the geometric primitives. Each surface being rendered to is associated with an abstract camera position. The camera position represents a location of a viewer looking at the scene and defines a viewing frustum that encloses the objects of the scene. The viewing frustum may include a viewing plane, a rear plane, and four clipping planes. Any geometric primitive entirely outside of the viewing frustum may be culled (e.g., discarded) because the geometric primitive will not contribute to the final rendered scene. Any geometric primitive that is partially inside the viewing frustum and partially outside the viewing frustum may be clipped (e.g., transformed into a new geometric primitive that is enclosed within the viewing frustum. Furthermore, geometric primitives may each be scaled based on a depth of the viewing frustum. All potentially visible geometric primitives are then transmitted to the rasterization stage 960.

The rasterization stage 960 converts the 3D geometric primitives into 2D fragments (e.g. capable of being utilized for display, etc.). The rasterization stage 960 may be configured to utilize the vertices of the geometric primitives to setup a set of plane equations from which various attributes can be interpolated. The rasterization stage 960 may also compute a coverage mask for a plurality of pixels that indicates whether one or more sample locations for the pixel intercept the geometric primitive. In an embodiment, z-testing may also be performed to determine if the geometric primitive is occluded by other geometric primitives that have already been rasterized. The rasterization stage 960 generates fragment data (e.g., interpolated vertex attributes associated with a particular sample location for each covered pixel) that are transmitted to the fragment shading stage 970.

The fragment shading stage 970 processes fragment data by performing a set of operations (e.g., a fragment shader or a program) on each of the fragments. The fragment shading stage 970 may generate pixel data (e.g., color values) for the fragment such as by performing lighting operations or sampling texture maps using interpolated texture coordinates for the fragment. The fragment shading stage 970 generates pixel data that is transmitted to the raster operations stage 980.

The raster operations stage 980 may perform various operations on the pixel data such as performing alpha tests, stencil tests, and blending the pixel data with other pixel data corresponding to other fragments associated with the pixel. When the raster operations stage 980 has finished processing the pixel data (e.g., the output data 902), the pixel data may be written to a render target such as a frame buffer, a color buffer, or the like.

It will be appreciated that one or more additional stages may be included in the graphics processing pipeline 900 in addition to or in lieu of one or more of the stages described above. Various implementations of the abstract graphics processing pipeline may implement different stages. Furthermore, one or more of the stages described above may be excluded from the graphics processing pipeline in some embodiments (such as the geometry shading stage 940). Other types of graphics processing pipelines are contemplated as being within the scope of the present disclosure. Furthermore, any of the stages of the graphics processing pipeline 900 may be implemented by one or more dedicated hardware units within a graphics processor such as PPU 600. Other stages of the graphics processing pipeline 900 may be implemented by programmable hardware units such as the SM 740 of the PPU 600.

The graphics processing pipeline 900 may be implemented via an application executed by a host processor, such as a CPU. In an embodiment, a device driver may implement an application programming interface (API) that defines various functions that can be utilized by an application in order to generate graphical data for display. The device driver is a software program that includes a plurality of instructions that control the operation of the PPU 600. The API provides an abstraction for a programmer that lets a programmer utilize specialized graphics hardware, such as the PPU 600, to generate the graphical data without requiring the programmer to utilize the specific instruction set for the PPU 600. The application may include an API call that is routed to the device driver for the PPU 600. The device driver interprets the API call and performs various operations to respond to the API call. In some instances, the device driver may perform operations by executing instructions on the CPU. In other instances, the device driver may perform operations, at least in part, by launching operations on the PPU 600 utilizing an input/output interface between the CPU and the PPU 600. In an embodiment, the device driver is configured to implement the graphics processing pipeline 900 utilizing the hardware of the PPU 600.

Various programs may be executed within the PPU 600 in order to implement the various stages of the graphics processing pipeline 900. For example, the device driver may launch a kernel on the PPU 600 to perform the vertex shading stage 920 on one SM 740 (or multiple SMs 740). The device driver (or the initial kernel executed by the PPU 600) may also launch other kernels on the PPU 600 to perform other stages of the graphics processing pipeline 900, such as the geometry shading stage 940 and the fragment shading stage 970. In addition, some of the stages of the graphics processing pipeline 900 may be implemented on fixed unit hardware such as a rasterizer or a data assembler implemented within the PPU 600. It will be appreciated that results from one kernel may be processed by one or more intervening fixed function hardware units before being processed by a subsequent kernel on an SM 740.

### Machine Learning

Deep neural networks (DNNs) developed on processors, such as the PPU 600 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 600. Inferencing is less compute-intensive than training, being a latency-sensitive process where a trained neural network is applied to new inputs it has not seen before to classify images, translate speech, and generally infer new information.

Neural networks rely heavily on matrix math operations, and complex multilayered networks require tremendous amounts of floating-point performance and bandwidth for both efficiency and speed. With thousands of processing cores, optimized for matrix math operations, and delivering tens to hundreds of TFLOPS of performance, the PPU 600 is a computing platform capable of delivering performance required for deep neural network-based artificial intelligence and machine learning applications.

### Example Data Center

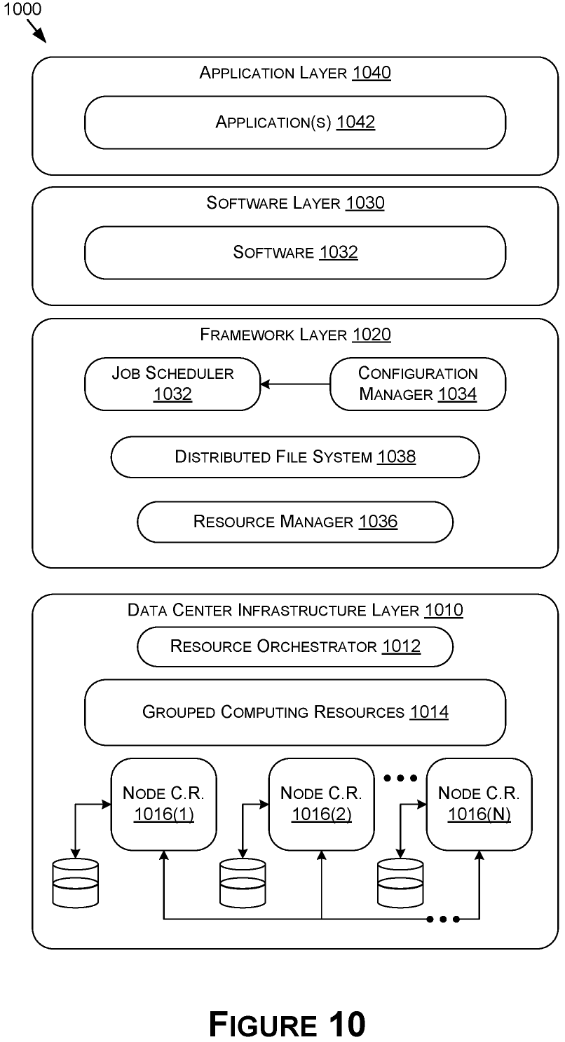

FIG. 10 illustrates an example data center 1000 that may be used in at least one embodiments of the present disclosure. The data center 1000 may include a data center infrastructure layer 1010, a framework layer 1020, a software layer 1030, and/or an application layer 1040.

As shown in FIG. 10, the data center infrastructure layer 1010 may include a resource orchestrator 1012, grouped computing resources 1014, and node computing resources (“node C.R.s”) 1016(1)-1016(N), where “N” represents any whole, positive integer. In at least one embodiment, node C.R.s 1016(1)-1016(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1016(1)-1016(N) may correspond to a server having one or more of the above-mentioned computing resources. In addition, in some embodiments, the node C.R.s 1016(1)-10161(N) may include one or more virtual components, such as vGPUs, vCPUs, and/or the like, and/or one or more of the node C.R.s 1016(1)-1016(N) may correspond to a virtual machine (VM).

In at least one embodiment, grouped computing resources 1014 may include separate groupings of node C.R.s 1016 housed within one or more racks (not shown), or many racks housed in data centers at various geographical locations (also not shown). Separate groupings of node C.R.s 1016 within grouped computing resources 1014 may include grouped compute, network, memory or storage resources that may be configured or allocated to support one or more workloads. In at least one embodiment, several node C.R.s 1016 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1012 may configure or otherwise control one or more node C.R.s 1016(1)-1016(N) and/or grouped computing resources 1014. In at least one embodiment, resource orchestrator 1012 may include a software design infrastructure (SDI) management entity for the data center 1000. The resource orchestrator 1012 may include hardware, software, or some combination thereof.

In at least one embodiment, as shown in FIG. 10, framework layer 1020 may include a job scheduler 1032, a configuration manager 1034, a resource manager 1036, and/or a distributed file system 1038. The framework layer 1020 may include a framework to support software 1032 of software layer 1030 and/or one or more application(s) 1042 of application layer 1040. The software 1032 or application(s) 1042 may respectively include web-based service software or applications, such as those provided by Amazon Web Services, Google Cloud and Microsoft Azure. The framework layer 1020 may be, but is not limited to, a type of free and open-source software web application framework such as Apache Spark™ (hereinafter “Spark”) that may utilize distributed file system 1038 for large-scale data processing (e.g., “big data”). In at least one embodiment, job scheduler 1032 may include a Spark driver to facilitate scheduling of workloads supported by various layers of data center 1000. The configuration manager 1034 may be capable of configuring different layers such as software layer 1030 and framework layer 1020 including Spark and distributed file system 1038 for supporting large-scale data processing. The resource manager 1036 may be capable of managing clustered or grouped computing resources mapped to or allocated for support of distributed file system 1038 and job scheduler 1032. In at least one embodiment, clustered or grouped computing resources may include grouped computing resource 1014 at data center infrastructure layer 1010. The resource manager 1036 may coordinate with resource orchestrator 1012 to manage these mapped or allocated computing resources.

In at least one embodiment, software 1032 included in software layer 1030 may include software used by at least portions of node C.R.s 1016(1)-1016(N), grouped computing resources 1014, and/or distributed file system 1038 of framework layer 1020. One or more types of software may include, but are not limited to, Internet web page search software, e-mail virus scan software, database software, and streaming video content software.

In at least one embodiment, application(s) 1042 included in application layer 1040 may include one or more types of applications used by at least portions of node C.R.s 1016(1)-1016(N), grouped computing resources 1014, and/or distributed file system 1038 of framework layer 1020. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1034, resource manager 1036, and resource orchestrator 1012 may implement any number and type of self-modifying actions based on any amount and type of data acquired in any technically feasible fashion. Self-modifying actions may relieve a data center operator of data center 1000 from making possibly bad configuration decisions and possibly avoiding underutilized and/or poor performing portions of a data center.

The data center 1000 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1000. In at least one embodiment, trained or deployed machine learning models corresponding to one or more neural networks may be used to infer or predict information using resources described above with respect to the data center 1000 by using weight parameters calculated through one or more training techniques, such as but not limited to those described herein.

In at least one embodiment, the data center 1000 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 600 of FIG. 6 - e.g., each device may include similar components, features, and/or functionality of the computing device(s) 600. In addition, where backend devices (e.g., servers, NAS, etc.) are implemented, the backend devices may be included as part of a data center 1000, an example of which is described in more detail herein with respect to FIG. 10.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments - in which case a server may not be included in a network environment - and one or more client-server network environments - in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 600 described herein with respect to FIG. 6. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A processor comprising:
one or more circuits to:
generate a first set of solutions within a search space associated with a combinatorial optimization problem;
operate a set of compute engines to determine, in parallel using at least one parallel processing unit, a set of improvements to the first set of solutions;
determine a subset of improvements of the set of improvements satisfy a set of constraints associated with the combinatorial optimization problem;
transmit data causing the subset of improvements to be applied to the first set of solutions to generate a second set of solutions within the search space; and
provide a solution corresponding to the second set of solutions based at least in part on a value computed based at least in part on a objective function that optimizes one or more features of the combinatorial optimization problem.

2. The processor of claim 1, wherein generating the first set of solutions further comprises modifying a set of hyperparameters of an insertion algorithm.

3. The processor of claim 1, wherein the at least one parallel processing unit further comprises at least one Graphical Processing Unit (GPU).

4. The processor of claim 1, wherein the combinatorial optimization problem is at least one of a traveling salesman, a vehicle routing problem, a bin packing problem, or a job shop scheduling problem.

5. The processor of claim 1, wherein determining the set of improvements comprises:
determining, by a first compute engine, an improvement comprises a local minimum within the search space; and
selecting a neighbor solution to the improvement within the search space.

6. The processor of claim 5, wherein determining the improvement comprises the local minimum further comprises recording, by the first compute engine, the improvement in a penalty list.

7. The processor of claim 6, wherein the penalty list is accessible to the set of compute engines.

8. The processor of claim 1, wherein the processor is comprised in at least one of:
a control system for an autonomous or semi-autonomous machine;
a system for performing simulation operations;
a system for performing deep learning operations;
a system implemented using an edge device;
a system implemented using a robot;
a system incorporating one or more virtual machines (VMs);
a system implemented at least partially in a data center; or
a system implemented at least partially using cloud computing resources.

9. A system comprising:
one or more processing units; and
one or more memory units storing instructions that, as a result of being executed by the one or more processing units, cause the one or more processing units to execute operations comprising:
initiating a set of compute engines on a set of parallel processing units, the set of compute engines being assigned a first set of solutions to a combinatorial optimization problem;
transmit data causing the set of parallel processing units to execute the set of compute engines in parallel to determine a set of improvements to apply to the first set of solutions to generate a second set of solutions to the combinatorial optimization problem; and
determining a solution to the combinatorial optimization problem based at least in part on an objective function computed based at least in part on the second set of solutions, where the objective function optimizes a feature of the combinatorial optimization problem.

10. The system of claim 9, wherein the combinatorial optimization problem comprises a vehicle routing problem.

11. The system of claim 9, wherein instructions that cause the one or more processing units to determine the set of improvements further include instructions that, as a result of being executed by the one or more processing units, cause the one or more processing units to determine a set of intra-route improvements.

12. The system of claim 9, wherein instructions that cause the one or more processing units to determine the set of improvements further include instructions that, as a result of being executed by the one or more processing units, cause the one or more processing units to determine a set of inter-route improvements.

13. The system of claim 9, wherein determining the set of improvements includes determining a set of intra-route improvements and a set of inter-route improvements in parallel.

14. The system of claim 9, wherein instructions that cause the one or more processing units to determine the solution further include instructions that, as a result of being executed by the one or more processing units, cause the one or more processing units to determine the solution satisfies one or more constraints associated with the combinatorial optimization problem.

15. The system of claim 9, wherein the system is comprised in at least one of:
a control system for an autonomous or semi-autonomous machine;
a system for performing simulation operations;
a system for performing deep learning operations;
a system implemented using an edge device;
a system implemented using a robot;
a system incorporating one or more virtual machines (VMs);
a system implemented at least partially in a data center; or
a system implemented at least partially using cloud computing resources.

16. A method comprising:
transmitting data causing a parallel processing unit to execute a plurality of compute engines, to perform, at least substantially in parallel, operations of a search algorithm within a search space of a combinatorial optimization problem; and
obtaining a solution from a compute engine of the plurality of compute engines.

17. The method of 16, wherein the compute engine comprises at least one of a hill climber, a local optimizer, or a solver.

18. The method of 16, wherein the combinatorial optimization problem comprises at least one of a traveling salesman problem, a vehicle routing problem, a bin packing problem, or a job shop scheduling problem.

19. The method of 16, wherein two or more of the operations of the search algorithm are executed at least substantially in parallel by the parallel processing unit.

20. The method of 16, wherein the parallel processing unit comprises a graphical processing unit.

21. The method of 16, wherein the operations of the search algorithm comprise an insertion algorithm to generate an initial set of solutions within the search space.

22. The method of 21, wherein the initial set of solutions are variated by at least modifying a set of hyperparameters associated with the insertion algorithm.

23. The method of 21, wherein solutions of the initial set of solutions are assigned to compute engines of the plurality of compute engines.

24. The method of 16, wherein the operations of the search algorithm further comprise a tabu search to avoid local maxima.

25. The method of 16, wherein compute engines of the plurality of compute engines are assigned a status of a set of statutes based at least in part on a result of the operations of the search algorithm the compute engine is performing.
